(19) United States
(12) Patent Application Publication
(10) Pub. No.: US 2002/0123920 A1
(43) Pub. Date: Sep. 5, 2002

(54) Integrated enterprise and product design and transformation system

(76) Inventor: Nicolaas Deetlef Du Preez, Stellenbosch (ZA)

Correspondence Address: BOURQUE & ASSOCIATES, P.A., 835 HANOVER STREET, SUITE 303, MANCHESTER, NH, 03104, US

(21) Appl. No.: 10/049,089

(22) PCT Filed: Jun. 5, 2001
(86) PCT No.: PCT/IB01/00968

(30) Foreign Application Priority Data
Jun. 6, 2000 (AU) 2000/2828

(51) Int. Cl. G06F 17/60

(52) U.S. Cl. 705/7

(57) ABSTRACT

The present invention relates to an integrated system and a method for designing, developing and guiding an enterprise and its products through various phases from inception to discontinuation of use. The system includes various components, namely an implementation procedure reference framework for structuring a product development during its design phase, its maturity phase and its disposal phase; a product information means for supplying and comparing details of a product at any time during all its phases with the implementation procedure reference framework; and a change effecting means adapted to effect changes to a product as required after comparison with the implementation reference framework.

### FIELD OF INVENTION

The present invention relates to an integrated enterprise and product design and transformation system.

More particularly, the present invention relates to an integrated system for designing, developing and guiding an enterprise and its products through various phases from inception to discontinuation of use.

### BACKGROUND TO INVENTION

U.S. Pat. No. 5,745,895 (Bingham et al) discloses a coherent method for the creating, capturing, and retrieving of ideas, concepts, data, and/or multimedia information. The system establishes a framework in which knowledge can be represented. The system is a computer-based system which utilizes multimedia, databases, and mass storage to implement this framework. It has an architecture and an open-ended-set of functional elements that combine to support knowledge processing. Knowledge is created by uniquely identifying and interrelating heterogeneous datasets located locally on a user's workstation or dispersed across computer networks.

In U.S. Pat. No. 5,418,943 (Borgida et al) there is disclosed an apparatus and a method for integrating a knowledge base management system with a data base system. The knowledge base management system employs compositional descriptions which describe information in terms of concepts. A translation component of the apparatus translates compositional descriptions into data base queries, so that information matching a compositional description may be retrieved from the data base.

U.S. Pat. No. 5,644,686 (Hekmatpour) describes an expert system and processing method employing a three level hierarchical knowledge base that has a plurality of nodes coupled together.

In U.S. Pat. No. 6,236,994 B1 (Swartz et al) there is disclosed a method and apparatus for first integrating the operation of various independent software applications directed to the management of information within an enterprise. The system architecture is, however, an expandable architecture, with built-in knowledge integration features that facilitate the monitoring of information flow into, out of, and between the integrated information management applications so as to assimilate knowledge information and facilitate the control of such information.

It is therefore clear, in particular from the patent specifications referred to above, that various methods and systems have been suggested to manage knowledge and information. However, no disclosure has been made regarding an integrated enterprise and product design and transformation system.

The life cycle of any enterprise or product can be divided into three phases, namely a design phase, a maturity phase and a disposal phase. Most changes are made to the product during the design phase. Relatively few changes to meet the industry's or customers' changing requirements are made during the maturity phase.

The cost of changing the design at any stage in the life cycle of a product increases exponentially with time. In order to keep costs down, all changes must be made as early in the life cycle as possible, i.e. during the design phase.

The expression “product” as henceforth used in this specification refers to an article, a method or an enterprise.

It is an object of the invention to suggest an integrated enterprise and product design and transformation system to anticipate and effect changes as early as possible. This facilitates the design process and provides a competitive edge as well as related financial advantage.

### SUMMARY OF INVENTION

An integrated enterprise and product design and transformation system, includes:

(a) an implementation procedure reference framework for structuring a product development during its design phase, its maturity phase and its disposal phase;

(b) a product information means for supplying and comparing details of a product at any time during all its phases with the implementation procedure reference framework; and

(c) a change effecting means adapted to effect changes to a product as required after comparison with the implementation reference framework.

Also according to the invention, a method of designing and transforming a product through various stages, includes the steps of

(a) setting up an implementation procedure reference frame work for structuring a product development during its design phase, its maturity phase and its disposal phase;

(b) supplying and comparing details of a product at any time during all its phases with the implementation procedure reference framework; and

(c) effecting changes to a product as required after comparison with the implementation reference framework.

The system may be adapted to create a product life cycle and/or an enterprise life cycle.

The product life cycle and the enterprise life cycle may form a framework for capturing information to provide an integrated design frame work about a product design, an enterprise design and interaction between the product design and the enterprise design.

The product life cycle and the enterprise life cycle may be considered in parallel when implementing changes.

The implementation procedure framework may also serve as a re-implementation procedure framework.

The integrated design frame work may include knowledge object examples, design examples and document templates.

The system may be adapted to prompt a user with applicable design objectives and/or performance measures.

The system may include checklists to ensure that all tasks required are completed.

The system may include a data management system for design documentation to facilitate audit trails and re-usability of design related processes.

The system may include web centric and/or intranet facilitated custom design of business processes, products and enterprises.

The system may be adapted to provide system supports, which include:

an implementation support;

training and personnel development support;

cyber database support enterprise design knowledge management;

user group exchange support services.

The cyber database support may include an advanced data administration management system which utilizes publications of technology developments.

The system in accordance with the invention provides a design framework environment, which supports the virtual life cycles of enterprise design and product design concurrently. It further facilitates related life cycles such as process and technology management life cycles and provides a suitable configuration management environment for programmes, such as ISO 9000 implementation.

The design process of a product or an enterprise is normally performed by a design team. This team creates a range of design documentation which documentation is captured in a data management system to facilitate audit trails and re-usability of all design related processes. All information generated during an enterprise design implementation is stored in an enterprise design data management system.

The integrated enterprise and product design and transformation system in accordance with the invention makes use of design objectives, which tell the user towards what goal he is working. Knowledge objects are also incorporated to give examples of what other enterprises have done in that specific field. Every enterprise has a specific structure, the integrated enterprise and product design and transformation system provides for an enterprise design and transformation structure that is based on PERA (Purdue Enterprise Reference Architecture). The current enterprise parameters can then be entered into the design structure.

The integrated enterprise and product design and transformation system implementation procedure framework includes steps to be followed and which are divided into two groups: namely a master plan and a reference framework (also referred to as “architecture”).

The master planning process, based on a particular reference architecture, provides the user with a methodology for the preliminary investigation, feasibility study and initiation of an enterprise engineering project. Each step in the master plan and reference architecture is defined and described. The information and resources needed to carry out the desired tasks, are listed and the expected outcomes are described. This master planning and reference architecture focuses on re-design, from an “as-is” to a “to-be” state.

### BRIEF DESCRIPTION OF DRAWINGS

The invention will now be described by way of example with reference to the accompanying schematic drawings.

In the drawings there is shown in:

FIG. 1 a master plan of the integrated enterprise and product design and transformation system in accordance with the invention;

FIG. 2 a reference framework or architecture of the integrated enterprise and product design and transformation system in accordance with the invention;

FIG. 3 a product life cycle and an enterprise life cycle of a manufactured product or service in accordance with the invention;

FIG. 4 design objectives and resolution perspectives in accordance with the invention;

FIG. 5 a diagnostic spider web outlining functionalities in accordance with the invention;

FIG. 6 integration of the enterprise life cycle and the product life cycle in accordance with the invention; and

FIG. 7 integration of software environment, technology awareness dome and consultation, with existing enterprise systems in accordance with the invention.

### DETAILED DESCRIPTION OF DRAWINGS

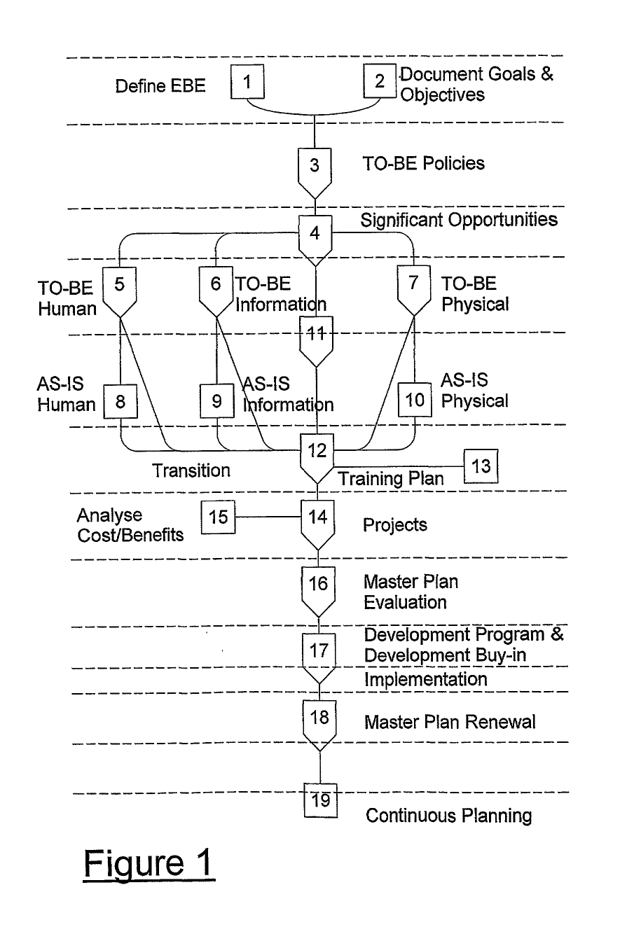

### FIGURE 1

Master Plan

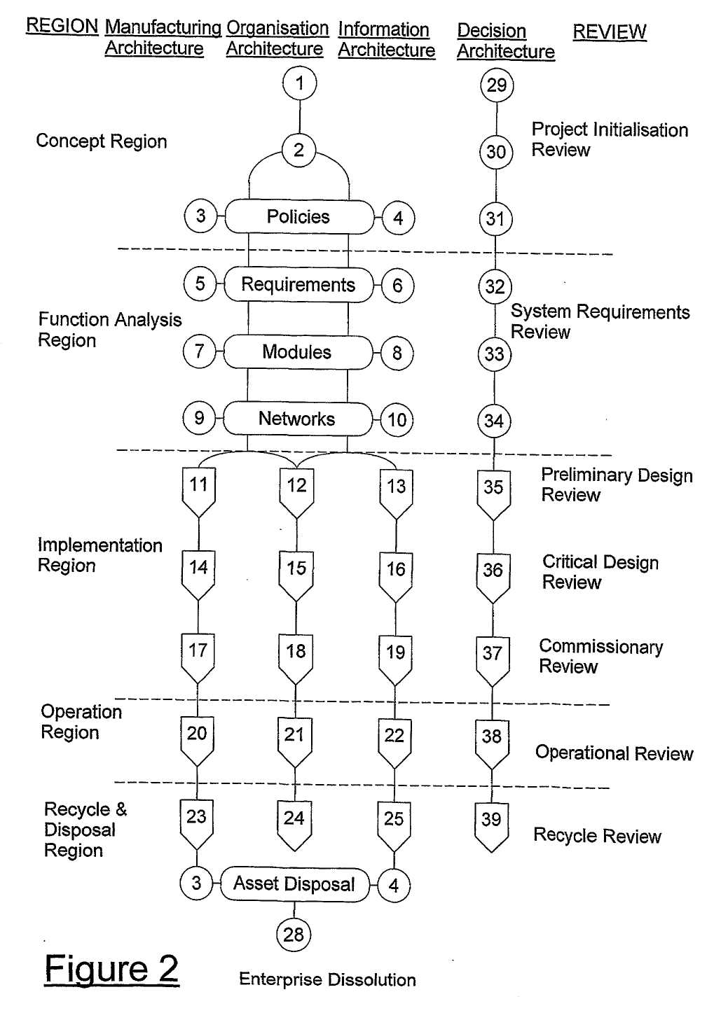

In FIG. 1 is shown a master plan which forms an important component of the PERA (Purdue Enterprise Reference Architecture). It provides the user with the necessary preliminary planning and operational guidance to be able to take full advantage of the technologies available. In the design phase the user can go through the steps of the master plan first. The feasibility of the project will then be determined. If it is feasible to continue, the user can follow the steps in the reference architecture (FIG. 2). Note: The acronym EBE stands for “Enterprise Business Entity”).

Navigator Window (not shown)

The navigator window indicates the position of the user within the integrated enterprise and product design and transformation system with respect to the enterprise life cycle or the product life cycle. It will assist the user to navigate through the entire design process, using both the master plan and reference architecture. It provides a visual guide to the different life cycles and methodologies. It will prompt the user to make certain decisions and will capture these decisions. The ability to capture information relative to a step or region within the navigator aids the enterprise design and transformation process by providing ease of access to the information and by capturing the context within which decisions are made.

Inputs

The generic input information lists what is needed in order to carry out the desired tasks in that phase/step of the master plan. It states the prerequisites to complete the step in the life cycle, for example what documents have to be completed at this stage, what information has to be available, etc.

Output

The generic output information lists what the expected outcomes would be on successful completion of the transformation desired in that phase/step of the master plan. Typical outputs will be documentation, policies and definitions.

Resources

The generic resource information lists which resources have to be committed in order to successfully complete the transformation process to take place in that step of the master plan. Resources are typically the people involved, computer programs or equipment.

Controls

The generic control information lists any information necessary in order to control how the information in that step of the master plan is being put to use. Controls refer to the constraints and feedback parameters within a step. Typical controls include the environment, safety and production requirements.

### FIGURE 2

Reference Architecture

A reference architecture for a given domain is shown in FIG. 2, which is a generic architecture from which others can be compared or derived. It is a framework on which enterprise design can be based. It consists of a methodology and a model that focuses on a re-design, from an “as-is” to a “to-be” state. An adapted version of the Purdue Enterprise Reference Architecture is implemented in the design method and system.

Each step in the reference architecture is defined and described in an additional information window. The tools, techniques and resources needed to carry out the desired tasks and the expected outcomes are listed.

Resources

The generic resource information describes which resources have to be committed in order to successfully complete the transformation process to take place in each of the reference architecture.

Hereafter various concepts used by the product control system are further explained.

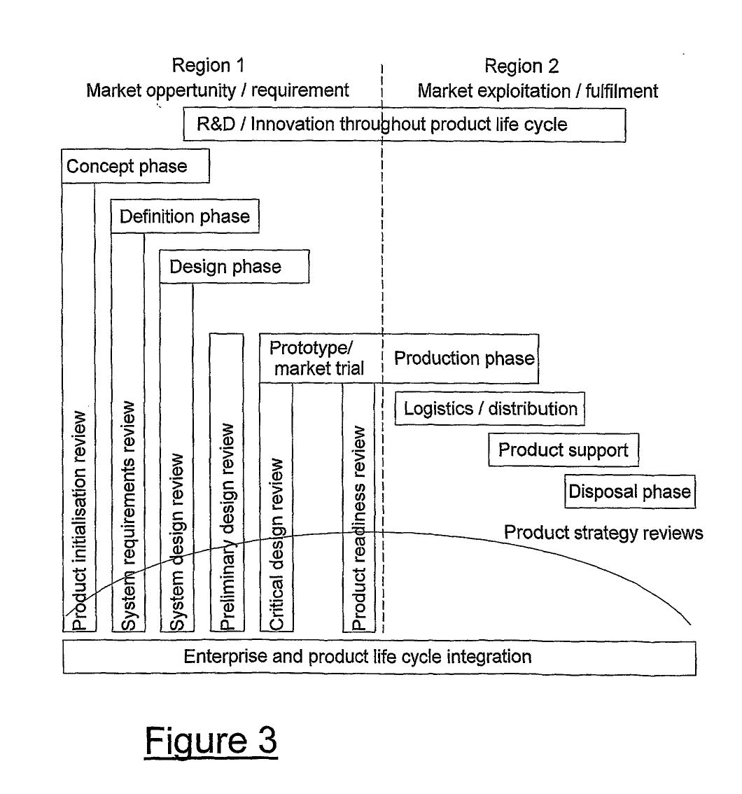

### FIGURE 3

Life Cycle

FIG. 3 describes the life cycle concept highlights the repetitive and reiterative nature of the enterprise or product and their design. It is important to realise that the life cycle does not denote a once off exercise, but rather a framework within which the design and re-design can take place. Such design and re-design is achieved by way of R & D (Research and Development) and Innovation. With the system the user follows the virtual life cycle, addressing each phase as required.

Enterprise Life Cycle

The enterprise life cycle represents the sequence of phases characterising the entire existence of an enterprise. These phases include enterprise inception, definition phase, requirements definition, system design and specification, system implementation and it covers all phases through to the disposal phase.

The life cycle has a time-related component as well as a view-related component. This creates a framework within which the user can view specified information.

Product Life Cycle

The product life cycle refers to all the stages that a product undergoes—from the concept phase to the disposal thereof.

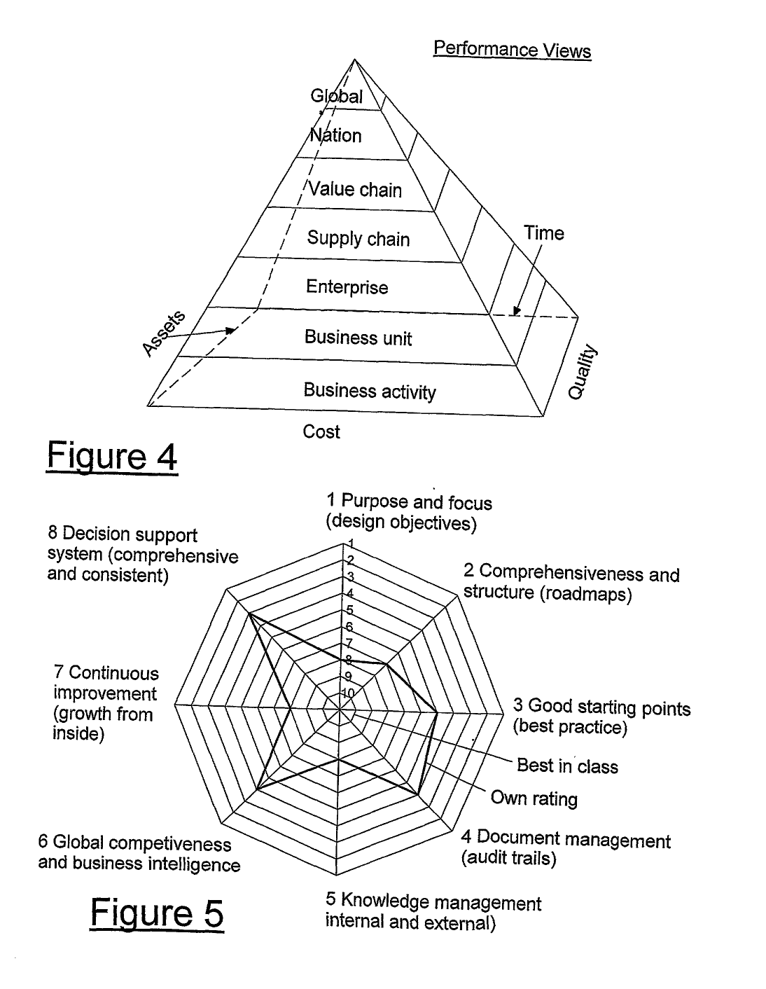

### FIGURE 4

Design Objectives

Design objectives are objectives to measure the performance of various product and enterprise entities. This is used to align the design processes and to prompt the design team to keep certain design criteria in mind when doing an enterprise engineering exercise.

FIG. 4 illustrates design objectives views and resolution perspectives. The pyramid indicates the resolution and performance views of the design objectives and knowledge management system.

Category

Category describes the functional area within a company where the design objectives will be applicable.

Resolution

This field tells the user in what resolution the design objectives have an impact. It positions the design objective in the relevant resolution ranging from global to a single process or activity.

Performance Impact

This field tells the user on what area the design objective focuses. It identifies the basic performance parameters influenced by a specific design objective. The four areas where a measurement can have an impact on a company are: cost, quality, assets and time.

Indicator

The indicator contains detail information concerning the design objective. This may include formulas and descriptions. It indicates how to achieve the design objective and is the indicator of performance in a specific step of the design. The design can be evaluated according to these indicators.

### FIGURE 5

Functionality Web

In FIG. 5 a functionality web is shown indicating various functions and relevant ratings.

Numbers 1 to 4 in FIG. 5 are applied when implementing the system in an enterprise. They are:

1 Clear design objectives, purpose and goals

2 Roadmaps for each improvement project

3 Best Practice starting points and benchmarking

4 The disciplined use of the integrated document management system.

Numbers 5 to 8 in FIG. 5 are improvements obtained by the system's integration of different systems within the client company. They are:

5 Knowledge Management

6 Business Intelligence

7 Continuous Improvement

8 Decision support.

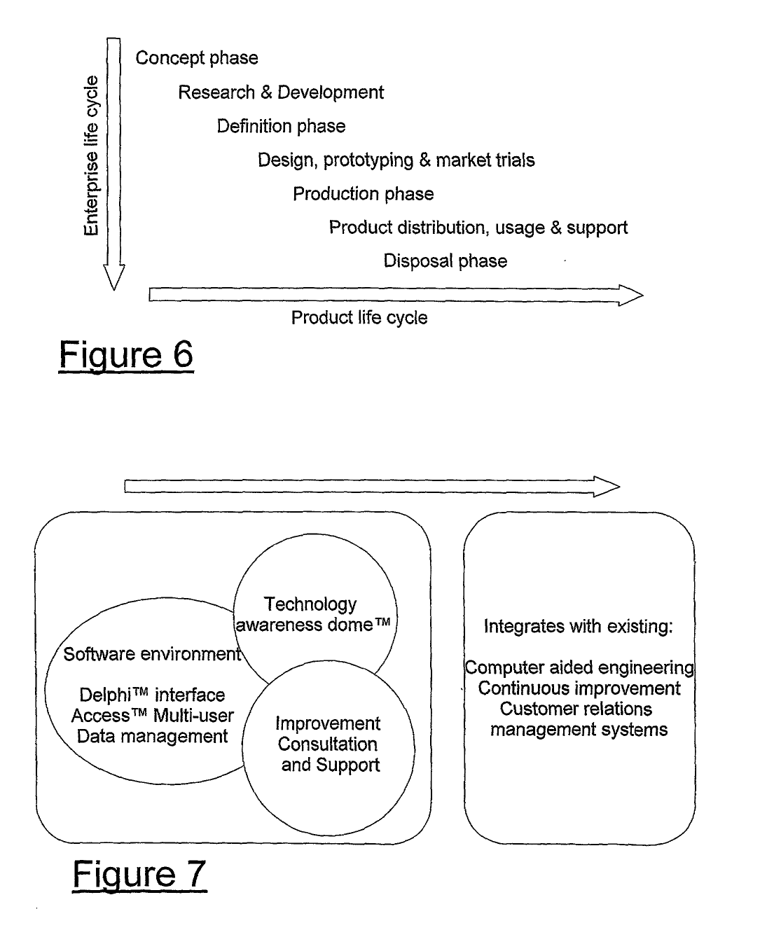

### FIGURE 6

Enterprise/Product Integration

FIG. 6 shows a diagram depicting a product life cycle from concept phase to disposal phase.

As continuous changes in the enterprise life cycle are being made (for example a change of specifications for a product), they are directly linked to the design review stage of the product life cycle roadmap in the system according to the invention.

This ensures alignment of product and enterprise improvement. A design review immediately takes any changes in the enterprise design into account.

### FIGURE 7

An integration structure is illustrated in FIG. 7.

### EXAMPLES

Each of the steps in the master plan in the reference architecture for the enterprise and that of the product life cycle provides illustrative examples. These are like pigeon holes and expand on the functions to be performed in each step.

The examples give an indication of how the navigator can be applied or implemented in practice. It can either be templates of required documentation, examples of completed templates or other additional information. To retrieve a document the user must double click on the file name. These examples can be dragged to the scratch pad.

Examples are linked to the master plan steps, the product life cycle steps and to products and outputs, method and systems and techniques or resources in the enterprise life cycle reference architecture functions.

### Enterprise Design Data Management System (EDDM)

All the data relevant to the specific step in the master plan or reference architecture must be added to the enterprise design data management system. This data is company specific, where the data in the scratch pad can be any data that is collected during the design process.

These files can be of general formats. Word™, Excel™, Zip, Mpeg and Wav extensions are typical acceptable formats. Documents can be added to the user data by dragging them from Windows Explorer™ and dropping them into the User Data window. Documents can also be transferred from the Scratch Pad™.

After inclusion of the document in the EDDM the program provides a data configuration management environment.

### OVERVIEW

Approach

The invention provides for the following:

1. a design objective database which provides design objectives on different levels of resolution and for different objectives such as cost, quality, time and asset utilization;

2. an enterprise design and product design structure with predefined pigeonholes and a methodology for deploying the design process ensures both comprehensiveness and integration of any design;

3. a knowledge management system continuously updating and expanding database of categorized best practice starting points for ensuring good departure points for the different components in the design process; and

4. the design process is deployed in orderly multi-user fashion using a unique integrated enterprise design data management system, which facilitates audit trails, multi-authoring, document security, and sustainability of the design process.

Thus the invention facilitates enterprise design projects and reduces the complexity of multidisciplinary teamwork by providing a user-friendly, scalable knowledge management supported framework, following a four-pronged approach to facilitate enterprise design and redesign as shown above:

The system may include web centric/intranet facilitated custom design of business processes, products and enterprises. It enables multi-disciplinary and intra-disciplinary teams to design quicker and more effectively by ensuring full re-usability and audit trails of the design processes.

The system thus provides for a dynamic environment that introduces the user to knowledge about various techniques, architectures and relevant information assisting the user's specific enterprise engineering and redesign processes. The product will guide the user through the steps to identify his/her needs, set up requirements, and record the user documentation and logic as the user is working on the enterprise engineering process.

The Design Framework

The system utilises virtual product and enterprise life cycle matrices to create a framework within which all the elements of an enterprise can be identified, described, specified, designed, deployed and integrated for operation. In doing so it facilitates and promotes enterprise integration. The framework makes use of various enterprise transformation methodologies such as the Purdue enterprise reference architecture methodology as a generic enterprise life cycle methodology.

Throughout the framework, the user is enabled with best practice information regarding the design and re-design of the enterprise and/or a selected part of it. The full impact of this framework is realized by creating the enterprise design navigator. The system provides a complete roadmap to aid the “What” and “How” of the enterprise engineering design process applied to a single enterprise, aligned to produce a series of one or more products. The system guides the user to follow a series of design steps within a methodology providing design objectives, structure procedures, good starting points and a document management system.

Initially the system will guide the user through a complete enterprise transformation exercise. After this initial use of the design method and system, the user will be able to use the product to implement incremental changes in an integrated manner. This is done by considering the life cycles of both the enterprise and the product in parallel, thus giving the user a framework addressing all (or most) factors that would impact on a decision made.

The system provides design objectives to measure the performance of various product and enterprise design projects. This is used to align the design processes and to prompt the design team to keep certain design criteria in mind when doing an enterprise engineering exercise.

Data Management

The system is more than just a structured source of information. It is a system using information as a resource, to assist the user during a decision making process. It will also provide the user with the ability to store his/her own information (relative to or alongside the best practice information). In doing so the user will build up a complete documented model of the knowledge objects describing his/her enterprise being designed or re-designed. This enterprise design data history allows the designer to capture his or her design intent.

The system may include web centric/intranet facilitated custom design of business processes, products and enterprises.

Support Functions

The system may also provide system supports, which may include:

an implementation support;

training and personnel development support;

cyber database support enterprise design knowledge management.

user group exchange support services.

The cyber database support may include an advanced data administration management system which utilizes publications of technology developments.

Value Added to Organisational Practices

The system creates an environment and an opportunity to access relevant enterprise engineering related information. It Will enhance the ability of management to:

Indicate the relative position of the enterprise/parts of the enterprise on the maturity scale.

Identify areas that require change or improvements that are feasible.

Measure enterprise performance.

Provide the necessary change suggestions to assemble an action plan.

Provide a custom made roadmap for the transition process.

Provide continuous support.

Provide purpose and focus for the transition process.

Research and development program.

Product selection criteria.

Some possible factors are: return on investment, risk characteristics, strategic importance.

1. An integrated enterprise and product design and transformation system, which includes:
(a) an implementation procedure reference framework for structuring a product development during its design phase, its maturity phase and its disposal phase;
(b) a product information means for supplying and comparing details of a product at any time during all its phases with the implementation procedure reference framework; and
(c) a change effecting means adapted to effect changes to a product as required after comparison with the implementation reference framework.

2. A system as claimed in claim 1, which is adapted to create a product life cycle and/or an enterprise life cycle.

3. A system as claimed in claim 2, in which the product life cycle and the enterprise life cycle form a framework for capturing information to provide an integrated design frame work about a product design, an enterprise design and interaction between the product design and the enterprise design.

4. A system as claimed in claim 2 or claim 3, in which the product life cycle and the enterprise life cycle are considered in parallel when implementing changes.

5. A system as claimed in claim 4, in which the implementation procedure framework also serves as a re-implementation procedure framework.

6. A system as claimed in claim 3, in which the integrated design frame work includes knowledge object examples, design examples and document templates.

7. A system as claimed in any one of the preceding claims, which is adapted to prompt a user with applicable design objectives and/or performance measures.

8. A system as claimed in any one of the preceding claims, which includes checklists to ensure that all tasks required are completed.

9. A system as claimed in any one of the preceding claims, which includes a data management system for design documentation to facilitate audit trails and re-usability of design related processes.

10. A system as claimed in any one of the preceding claims, which includes web centric and/or intranet facilitated custom design of business processes, products and enterprises.

11. A system as claimed in any one of the preceding claims, which is adapted to provide system supports, which include:
an implementation support;
training and personnel development support;
cyber database support enterprise design knowledge management;
user group exchange support services.

12. A system as claimed in claim 11, in which the cyber database support includes an advanced data administration management system which utilizes publications of technology developments.

13. A method of designing and transforming a product through various stages, which includes the steps of
(a) setting up an implementation procedure reference frame work for structuring a product development during its design phase, its maturity phase and its disposal phase;
(b) supplying and comparing details of a product at any time during all its phases with the implementation procedure reference framework; and
(c) effecting changes to a product as required after comparison with the implementation reference framework.

14. A system as claimed in claim 13, which includes the step of creating a product life cycle and/or an enterprise life cycle.

15. A method as claimed in claim 14, in which the product life cycle and the enterprise life cycle form a framework for capturing information to provide an integrated design frame work about a product design, an enterprise design and interaction between the product design and the enterprise design.

16. A method as claimed in claim 14 or claim 15, in which the product life cycle and the enterprise life cycle are considered in parallel when implementing changes.

17. A method as claimed in claim 16, in which the implementation procedure framework also serves as a re-implementation procedure framework.

18. A method as claimed in claim 15, in which the integrated design frame work includes knowledge object examples, design examples and document templates.

19. A method as claimed in any one of claims 13 to 18, which includes the steps of prompting a user with applicable design objectives and/or performance measures.

20. A method as claimed in any one of clams 13 to 19, which includes the step of providing checklists to ensure that all tasks required are completed.

21. A method as claimed in any one of claims 13 to 20, which includes the steps of providing a data management system for design documentation to facilitate audit trails and re-usability of design related processes.

22. A method as claimed in any one of claims 13 to 21, which includes the step of providing web centric and/or intranet facilitated custom design of business processes, products and enterprises.

23. A method as claimed in any one of clams 13 to 22, which includes the step of providing system supports, which include:
an implementation support;
training and personnel development support;
cyber database support enterprise design knowledge management;
user group exchange support services.

24. A method as claimed in claim 23, in which the cyber database support includes an advanced data administration management system which utilizes publications of technology developments.
